(19) United States
(12) Patent Application Publication
(10) Pub. No.: US 2012/0163010 A1
(43) Pub. Date: Jun. 28, 2012

(54) VEHICLE LAMP ADJUSTMENT ASSEMBLY

(75) Inventor: Kuo-Pin WU, Tainan City (TW)

(73) Assignee: MAXZONE AUTO PARTS CORP., Fontana, CA (US)

(21) Appl. No.: 13/337,360

(22) Filed: Dec. 27, 2011

(30) Foreign Application Priority Data
Dec. 28, 2010 (TW) 99225289

(51) Int. Cl. F21V 21/14

(52) U.S. Cl. 362/523

(57) ABSTRACT

A vehicle lamp adjustment assembly includes a fixed base, an insert, a U-shaped positioning member and a bolt. The fixed base defines an accommodating space therein. The insert is installed in the accommodating space of the fixed base. The insert has a through hole, a saw-toothed segment and a socket. The through hole passes axially through the insert. The saw-toothed segment is a ctenoid structure raised from the insert. The socket is at an outer periphery of the insert. The U-shaped positioning member has an indentation, by which the U-shaped positioning member engages with the socket of the insert. The bolt is screwed into the through hole of the insert and has a diameter slightly greater than a width of the indentation of the U-shaped positioning member. Thereby, the insert can be firmly positioned in the fixed base and be secured from disengagement.

### BACKGROUND OF THE INVENTION

1. Technical Field

The present invention relates to a vehicle lamp adjustment assembly, which is useful to prevent an installed insert from being disengaged thererfrom.

2. Description of Related Art

The progressing development of transportation tools provides modern people with a convenient life. When driving on road, a driver is responsible for not only his own safety, but also for the safety of other road users, including pedestrians and cars. Considering this, headlamps are both a lighting tool and a warning tool to vehicles driven on road.

For adjustment of the reflector in a headlamp, an insert is traditionally positioned in a fixed base of the reflector, for receiving a spherical head to adjust the headlamp. The existing insert typically has a plurality of elastic fins and a pad mounted around an end of the insert. The insert is positioned in the fixed base by the elasticity and deformation of the fins. Then the pad has its edge cutting into the inner wall of the fixed base, so as to enhance the positioning effect. However, the elastic fins are likely to suffer elastic fatigue and poor fixing strength. Thus, in the conventional design, the installed insert is likely to be disengaged and such disengagement can cause non-repairable mechanical damage to the headlamp.

### SUMMARY OF THE INVENTION

In view of this, the present invention provides a vehicle lamp adjustment assembly that eliminates the problem of the prior raised from to the tendency of the elastic fins toward elastic fatigue that can risk the installed insert disengaging.

According to one embodiment of the present invention, a vehicle lamp adjustment assembly comprises a fixed base, an insert, a U-shaped positioning member and a bolt. The fixed base defines an accommodating space. The insert is installed in the accommodating space of the fixed base. The insert has a through hole, a saw-toothed segment and a socket. The through hole passes axially through the insert. The saw-toothed segment is a ctenoid structure raised from the insert. The socket is at an outer periphery of the insert. The U-shaped positioning member has an indentation, by which the U-shaped positioning member engages with the socket of the insert. The bolt is screwed into the through hole of the insert and has a diameter slightly greater than a width of the indentation of the U-shaped positioning member.

In another embodiment of the present invention, the insert has a crisscross sectional shape. The U-shaped positioning member has a periphery formed with saw-teeth. The vehicle lamp adjustment assembly further has a pair of vertical tabs, a positioning stair, a positioning recess, a scoop and a fixing portion. The vertical tabs are formed along facing edges of the indentation of the U-shaped positioning member. The positioning stair is located in the accommodating space of the fixed base and integratedly formed on an inner wall of fixed base defining the accommodating space. The positioning recess is formed on the saw-toothed segment of the insert for engaging with the positioning stair thereby positioning the insert within the accommodating space of the fixed base. Therein, each of the positioning stair and the positioning recess comes in a number of two while the U-shaped positioning member additionally has a notch positionally corresponding to the pair of positioning stairs and the pair of positioning recesses. The scoop is formed in the saw-toothed segment and communicates to the through hole of the insert. The fixing portion is such integratedly formed on the insert that the fixing portion is located on one end of the insert opposite to the saw-toothed segment.

In another embodiment of the present invention, the saw-toothed segment of the vehicle lamp adjustment assembly may comprise a first saw-toothed segment and a second saw-toothed segment. A distance between a periphery of the second saw-toothed segment and a suppositional axis of the through hole is slightly smaller than a distance between a periphery of the first saw-toothed segment and the suppositional axis of the through hole. The accommodating space includes a first accommodating space and a second accommodating space. The first accommodating space is configured to match the distance between the periphery of the first saw-toothed segment and the suppositional axis of the through hole while the second accommodating space is configured to match the distance between the periphery of the second saw-toothed segment and the suppositional axis of the through hole, wherein the second accommodating space has an inner diameter slightly smaller than an inner diameter of the first accommodating space.

Therefore, from the above embodiments, it is learned that in virtue of the friction between the inner wall of the fixed base defining the accommodating space and the saw-toothed segment of the insert as well as the U-shaped positioning member, plus the design that the bolt is greater than the through hole in diameter, in the disclosed vehicle lamp adjustment assembly, when the bolt is screwed into the through hole, the saw-toothed segment of the insert and the U-shaped positioning member expand outward. Thereby, the installed insert can be firmly positioned in the fixed base and be secured from disengagement.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a partially cutaway view of a vehicle lamp adjustment assembly according to the present invention;

FIG. 2 is an exploded view of the vehicle lamp adjustment assembly of FIG. 1;

FIG. 3 are schematic views of different U-shaped positioning members of the vehicle lamp adjustment assembly of FIG. 1;

FIG. 4 is a cross-sectional view of the vehicle lamp adjustment assembly taken along the line 1-1 of FIG. 2;

FIG. 5 is a partially cutaway view of an alternative vehicle lamp adjustment assembly according to the present invention;

FIG. 6 is an exploded view of the vehicle lamp adjustment assembly of FIG. 5;

FIG. 7 is a cross-sectional view of the vehicle lamp adjustment assembly taken along the line 2-2 of FIG. 6;

FIG. 8 is a partially cutaway view of another alternative vehicle lamp adjustment assembly according to the present invention;

FIG. 9 is an exploded view of the vehicle lamp adjustment assembly of FIG. 8; and

FIG. 10 is a cross-sectional view of the vehicle lamp adjustment assembly taken along the line 3-3 of FIG. 9.

### DETAILED DESCRIPTION OF THE INVENTION

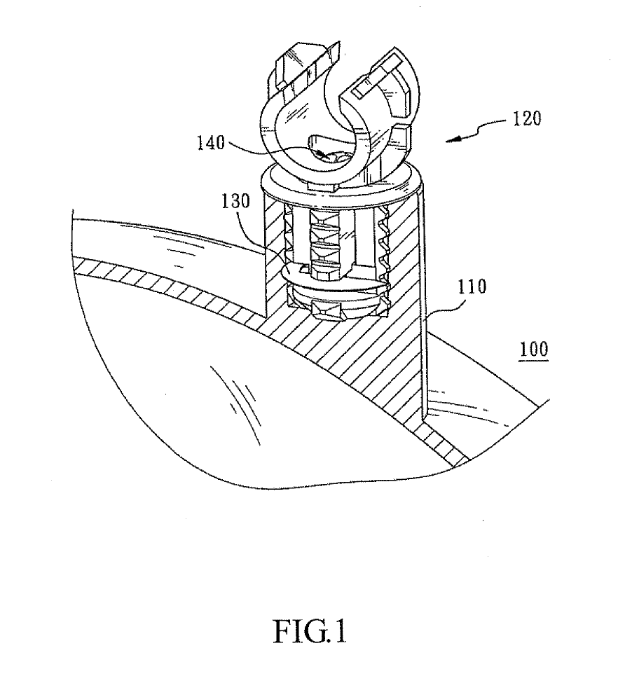

FIG. 1 is a partially cutaway view of a vehicle lamp adjustment assembly according to the present invention. As shown in FIG. 1, a vehicle lamp adjustment assembly 100 comprises a fixed base 110, an insert 120, a U-shaped positioning member 130 and a bolt 140. In virtue of the special configuration of the insert 120, which work together with the U-shaped positioning member 130 and the bolt 140, the insert 120 can be securely positioned within the fixed base 110, and prevented from disengagement.

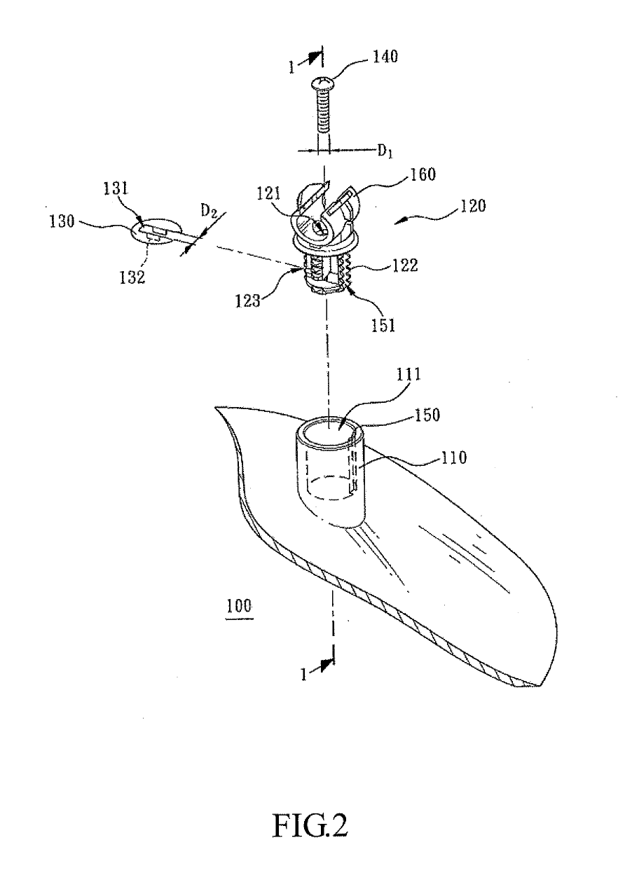

FIG. 2 is an exploded view of the vehicle lamp adjustment assembly of FIG. 1. As shown in FIG. 2, the fixed base 110 has an accommodating space 111. The insert 120 is installed in the accommodating space 111 of the fixed base 110. Therein, the insert 120 in the present embodiment has a crisscross sectional shape.

The insert 120 includes a through hole 121, a saw-toothed segment 122 and a socket 123. The through hole 121 extends axially through the insert 120.

The saw-toothed segment 122 is formed on the insert 120 as a ctenoid structure. The saw-toothed segment 122 has saw-teeth regularly arrayed on and raised from outer edges of the crisscross sectional shape of the insert 120. Therein, the saw-toothed segment 122, once received external force, deforms unrecoverably and permanently.

The socket 123 is formed at an outer periphery of the insert 120. In the present embodiment, the socket 123 is formed near a lower end of the insert 120.

The U-shaped positioning member 130 has an indentation 131 by which the U-shaped positioning member 130 is engaged with the socket 123 of the insert 120. Please refer to FIG, 3 for schematic views of different U-shaped positioning members of the vehicle lamp adjustment assembly of FIG. 1. As shown, the U-shaped positioning member 130 may have its periphery entirely or partially formed with saw-teeth.

Referring back to FIG. 2, the bolt 140 is to be screwed into the through hole 121 of the insert 120 and has its diameter slightly larger than the width of the indentation 131 of the U-shaped positioning member 130. In other words, the bolt 140 has a diameter slightly greater than that of the through hole 121. Thus, when screwed downward into the through hole 121 of the insert 120, the bolt 140 pushes the insert 120 and the U-shaped positioning member 130 outward, in turn making the saw-toothed segment 122 of the insert 120 and the U-shaped positioning member 130 expand outward.

When the insert 120 is placed into the accommodating space 111 of the fixed base 110, an inner wall of the fixed base 110 defining the accommodating space 111 has a first interference with the saw-toothed segment 122 of the insert 120. Afterward, the inner wall of the fixed base 110 defining the accommodating space 111 has a second interference with the U-shaped positioning member 130 coupled with the insert 120. At last, when the bolt 140 is screwed into the through hole 121, since the bolt 140 has its diameter slightly greater than the width of the indentation 131 of the U-shaped positioning member 130, the insert 120 and the U-shaped positioning member 130 both expand outward, so as to increase friction between the insert 120 and the inner wall of the fixed base 110 defining the accommodating space 111, and meantime edges of the U-shaped positioning member 130 cut into the inner wall of the fixed base 110 defining the accommodating space 111, so the insert 120 in positioned in the fixed base 110.

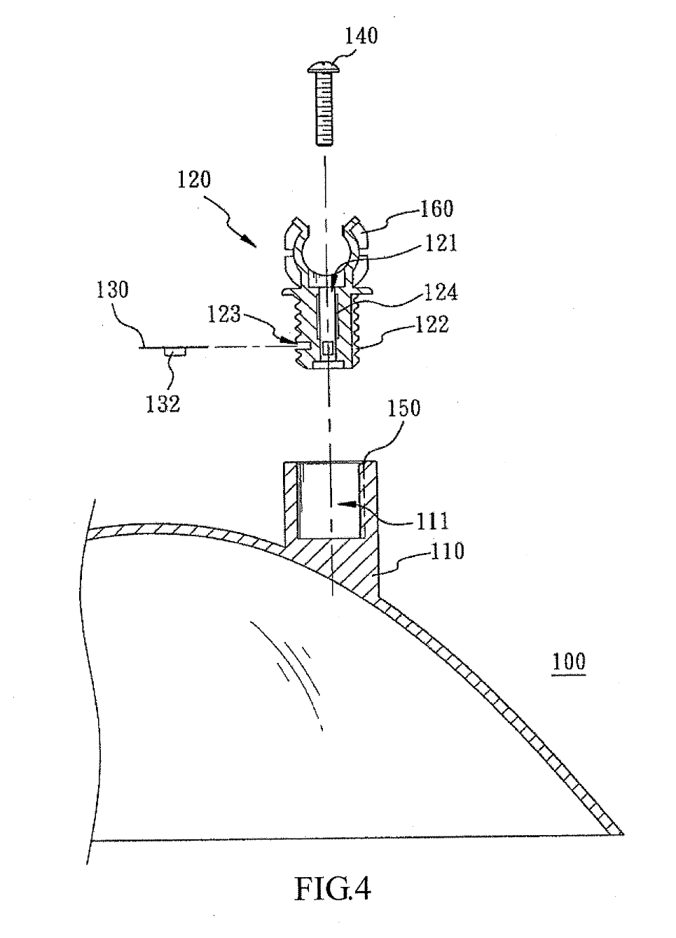

Now please refer to FIG. 2 and FIG. 4, FIG. 4 is a cross-sectional view of the vehicle lamp adjustment assembly taken along the line 1-1 of FIG. 2. As shown in FIG. 2 and FIG. 4, in the present embodiment, the vehicle lamp adjustment assembly 100 further comprises a pair of vertical tabs 132, a positioning stair 150, a positioning recess 151, a scoop 124 and a fixing portion 160.

The vertical tabs 132 are formed along facing edges of the indentation 131 of the U-shaped positioning member 130, for promoting deformation of the U-shaped positioning member 130. Therein, the bolt 140 has its diameter D₁ also slightly greater than a distance D₂ between the vertical tabs 132. Therefore, when the bolt 140 is screwed downward into the insert 120, the insert 120 is pushed outward to push the vertical tabs 132 outward, thereby increasing outward expansion, or deformation, of the U-shaped positioning member 130. Since the bolt 140 transfers force to the vertical tabs 132 through planar contact instead of linear contact, the force is applied to the vertical tabs 132 with improved uniformity, thereby facilitating deformation of the U-shaped positioning member 130.

The positioning stair 150 is provided in the accommodating space 111 of the fixed base 110, and is formed integratedly on the inner wall of the fixed base 110 defining the accommodating space 111, for preliminarily positioning the insert 120 in the accommodating space 111 of the fixed base 110.

The positioning recess 151 is formed in the saw-toothed segment 122 of the insert 120 for engaging with the positioning stair 150 and preliminarily positioning the insert 120 in the accommodating space 111 of the fixed base 110.

The scoop 124 is formed in the saw-toothed segment 122 and communicate to the through hole 121 of the insert 120, for allowing the insert 120 to deform well in response to the bolt 140 screwed thereinto.

The fixing portion 160 and the insert 120 are such integratedly formed that the fixing portion 160 is located on one end of the insert 120 opposite to the saw-toothed segment 122 and serves to connect other mechanisms of a vehicle, such as an adjustment lever having a spherical head.

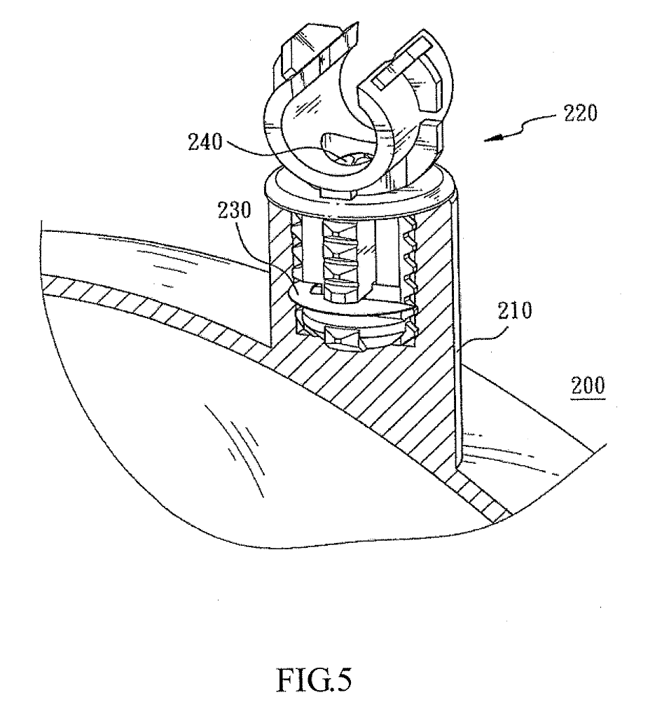

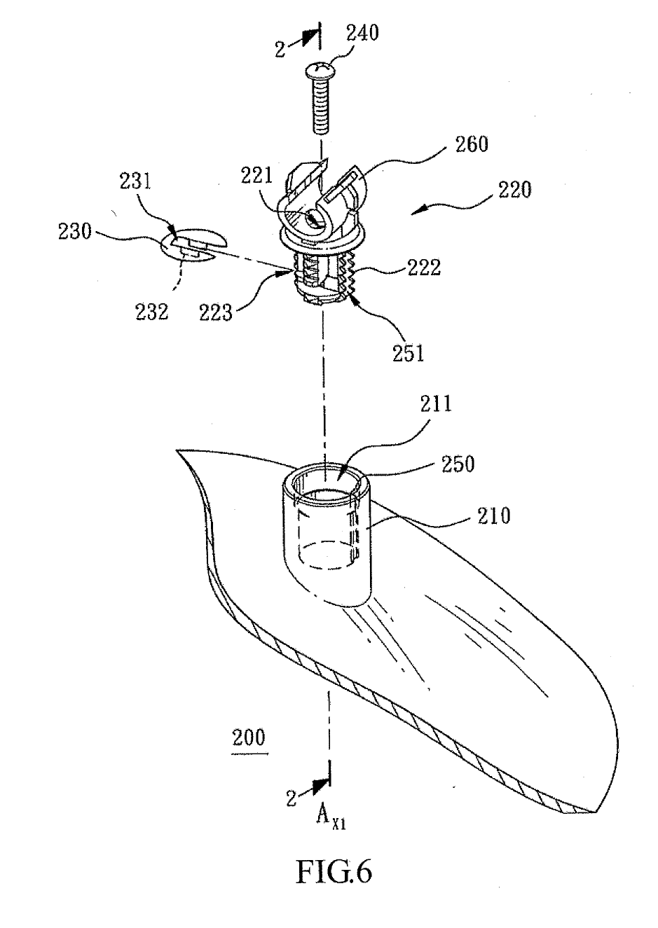

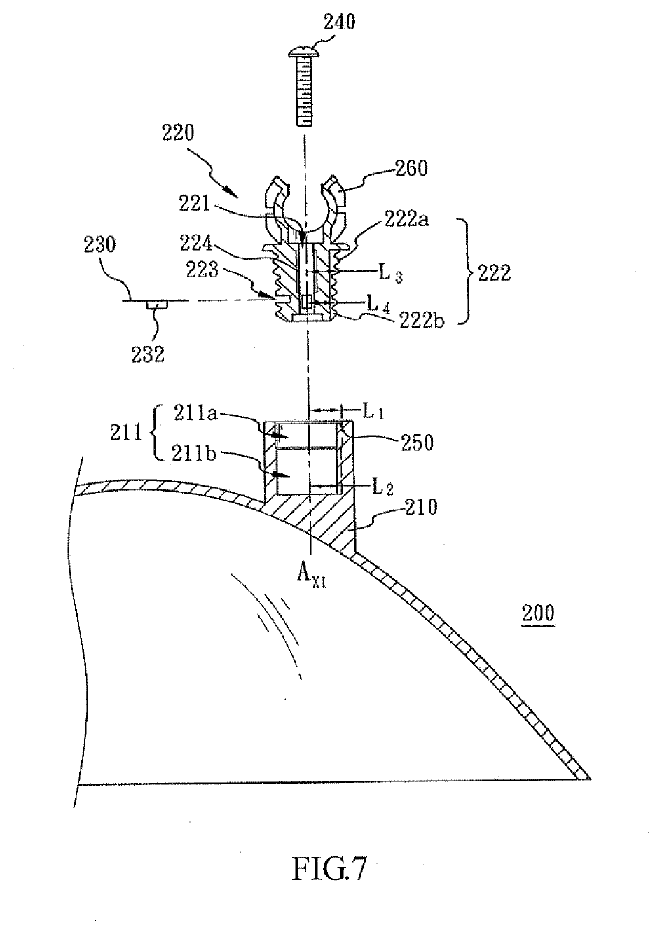

FIG. 5 is a partially cutaway view of an alternative vehicle lamp adjustment assembly according to the present invention. FIG. 6 is an exploded view of the vehicle lamp adjustment assembly of FIG. 5. FIG. 7 is a cross-sectional view of the vehicle lamp adjustment assembly taken along the line 2-2 of FIG. 6. As shown in FIG. 5 through FIG. 7, the vehicle lamp adjustment assembly 200 comprises a fixed base 210, an insert 220, a U-shaped positioning member 230 and a bolt 240.

The fixed base 210 defines an accommodating space 211. In the present embodiment, the accommodating space 211 of the vehicle lamp adjustment assembly 200 is composed of a first accommodating space 211a and a second accommodating space 211b, wherein the second accommodating space 211b has an inner diameter L₂ slightly smaller than an inner diameter L₁ of the first accommodating space 211 a. In other words, the vehicle lamp adjustment assembly 200 as depicted has its accommodating space 211 formed with two parts of different inner diameters L₁, L₂.

The insert 220 is to be installed into the accommodating space 211 of the fixed base 210. The insert 220 has a crisscross sectional shape. The insert 220 includes a through hole 221, a saw-toothed segment 222 and a socket 223.

The through hole 221 extends axially through the insert 220.

The saw-toothed segment 222 is formed on the insert 220 as a ctenoid structure. The saw-toothed segment 222 has saw-teeth regularly arrayed on and raised from edges of the crisscross sectional shape of the insert 220. Therein, the saw-toothed segment 222, once received external force, deforms unrecoverably and permanently.

Furthermore, the saw-toothed segment 222 includes a first saw-toothed segment 222a and a second saw-toothed segment 222b. The first saw-toothed segment 222a borders on the second saw-toothed segment 222b. A distance L₃ between a periphery of the first saw-toothed segment 222a and a suppositional axis Aₓ₁ of the through hole 221 is similar to the inner diameter L₁ of the first accommodating space 211a, while a distance L₄ between a periphery of the second saw-toothed segment 222b and the suppositional axis Aₓ₁ of the through hole 221 is similar to the inner diameter L₂ of the second accommodating space 211b. Thus, the distance L₃ between the periphery of the first saw-toothed segment 222a and a suppositional axis Aₓ₁ of the through hole 221 is slightly greater than the distance L₄ between the periphery of the second saw-toothed segment 222b and the suppositional axis Aₓ₁ of the through hole 221.

The socket 223 is formed at an outer periphery of the insert 220. In the present embodiment, the socket 223 is formed near a lower end of the insert 220.

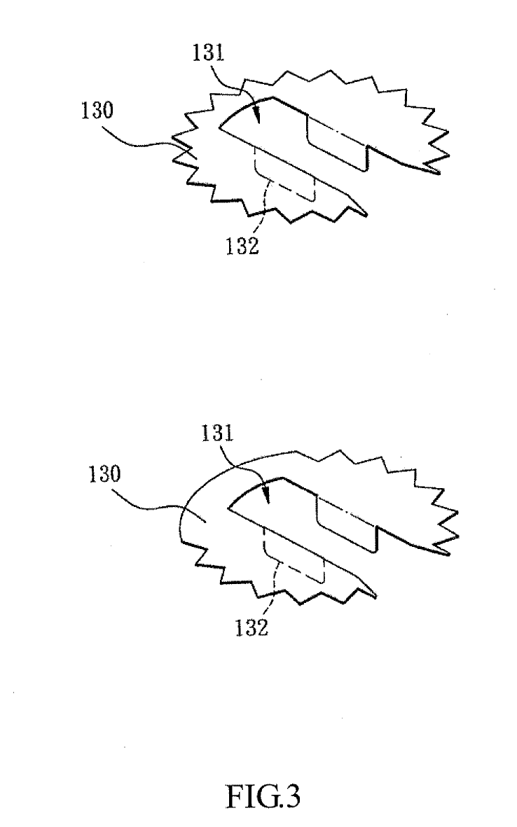

The U-shaped positioning member 230 has an indentation 231 by which the U-shaped positioning member 230 is engaged with the socket 223 of the insert 220. Referring to FIG. 3, the U-shaped positioning member 230 may have its periphery entirely or partially formed with saw-teeth. Since this part is similar to its counterpart in the vehicle lamp adjustment assembly 100 as described above, the detailed description is omitted herein.

The bolt 240 is to be screwed into the through hole 221, of the insert 220. Since the bolt 240 has its diameter slightly larger than the width of the indentation 231 of the U-shaped positioning member 230, when screwed downward into the insert 220, the bolt 240 pushes the insert 220 outward, in turn making the first saw-toothed segment 222a and the second saw-toothed segment 222b of the insert 220 expand outward.

When the insert 220 is placed into the accommodating space 211 of the fixed base 210, an inner wall of the fixed base 210 defining the accommodating space 211 has a first interference with the saw-toothed segment 222 of the insert 220. In the present embodiment, the accommodating space 211 and the saw-toothed segment 222 of the vehicle lamp adjustment assembly 200 are both of a two-stage structure, which enhances the extent of interference between the insert 220 and the fixed base 210. After the first interference, the inner wall of the fixed base 210 defining the accommodating space 211 has a second interference with the U-shaped positioning member 230 mounted around the insert 220. At last, when the bolt 240 is screwed into the through hole 221, since the bolt 240 has its diameter slightly greater than the width of the indentation 231 of the U-shaped positioning member 230, the insert 220 and the U-shaped positioning member 230 both expand outward, so as to increase friction between the insert 220 and the inner wall of the fixed base 210 defining the accommodating space 211, and meantime edges of the U-shaped positioning member 230 cut into the inner wall of the fixed base 210 defining the accommodating space 211, so the insert 220 in positioned in the fixed base 210.

Moreover, the vehicle lamp adjustment assembly 200 further comprises a pair of vertical tabs 232, a positioning stair 250, a positioning recess 251, a scoop 224 and a fixing portion 260. Since these components are similar to their counterparts of the vehicle lamp adjustment assembly 100 as described in the previous embodiment, the detailed description is omitted herein.

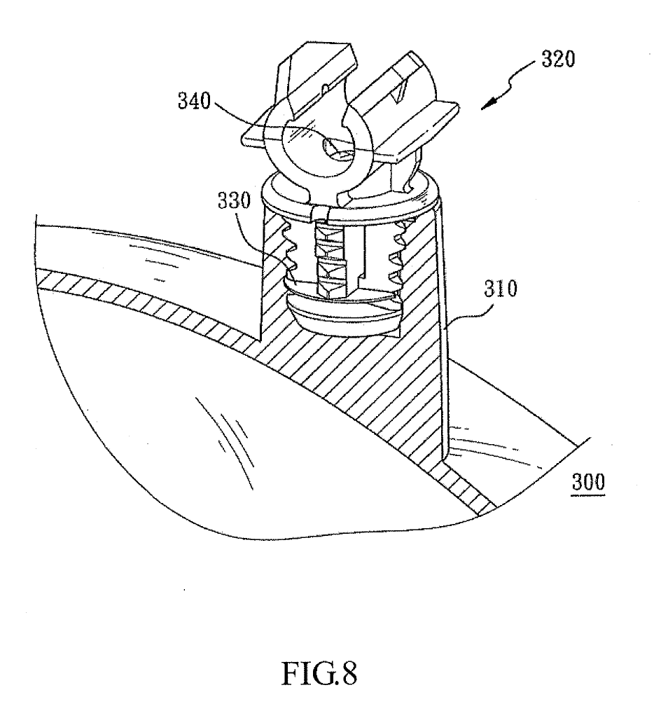

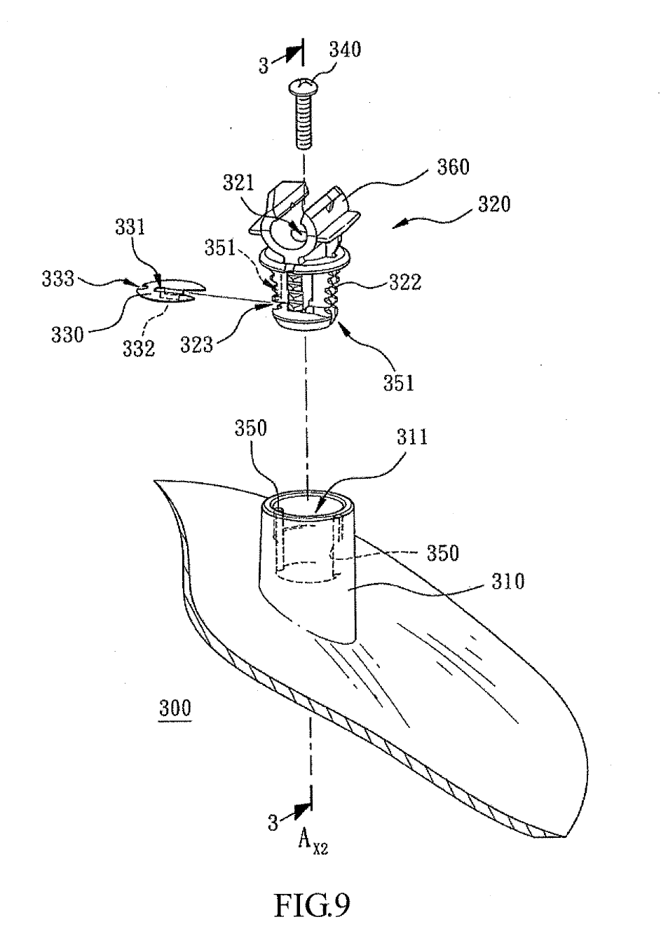

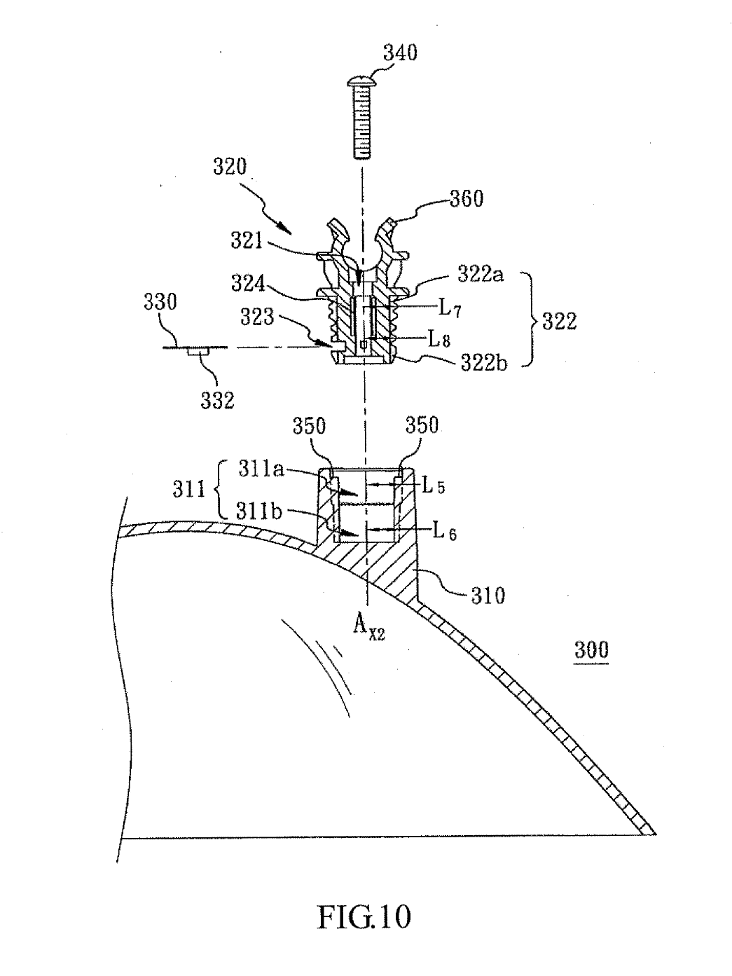

FIG. 8 is a partially cutaway view of another alternative vehicle lamp adjustment assembly according to the present invention. FIG. 9 is an exploded view of the vehicle lamp adjustment assembly of FIG. 8. FIG. 10 is a cross-sectional view of the vehicle lamp adjustment assembly taken along the line 3-3 of FIG. 9. As shown in FIG. 8 through FIG. 10, the vehicle lamp adjustment assembly 300 comprises a fixed base 310, an insert 320, a U-shaped positioning member 330 and a bolt 340.

The fixed base 310 defines an accommodating space 311. In the present embodiment, the accommodating space 311 of the vehicle lamp adjustment assembly 300 is composed of a first accommodating space 311a and a second accommodating space 311b, wherein the second accommodating space 311b has an inner diameter L₆ slightly smaller than an inner diameter L₅ of the first accommodating space 311a. In other words, the vehicle lamp adjustment assembly 300 as depicted has its accommodating space 311 formed with two parts of different inner diameters L₅, L₆.

The insert 320 is to be installed into the accommodating space 311 of the fixed base 310. The insert 320 has a crisscross sectional shape. The insert 320 includes a through hole 321, a saw-toothed segment 322 and a socket 323.

The through hole 321 extends axially through the insert 320.

The saw-toothed segment 322 is formed on the insert 320 as a ctenoid structure. The saw-toothed segment 322 has saw-teeth regularly arrayed on and raised from edges of the crisscross sectional shape of the insert 320. Therein, the saw-toothed segment 322, once received external force, deforms unrecoverably and permanently.

Furthermore, the saw-toothed segment 322 includes a first saw-toothed segment 322a and a second saw-toothed segment 322b. The first saw-toothed segment 322a borders on the second saw-toothed segment 322b. A distance L₇ between a periphery of the first saw-toothed segment 322a and a suppositional axis Aₓ₁ of the through hole 321 is similar to the inner diameter L₅ of the first accommodating space 311a, while a distance L₈ between a periphery of the second saw-toothed segment 322b and the suppositional axis Aₓ₂ of the through hole 321 is similar to the inner diameter L₆ of the second accommodating space 311b. Thus, the distance L₇ between the periphery of the first saw-toothed segment 322a and the suppositional axis Aₓ₂ of the through hole 321 is slightly greater than the distance L₈ between the periphery of the second saw-toothed segment 322b and the suppositional axis Aₓ₂ of the through hole 321.

The socket 323 is formed at an outer periphery of the insert 320. In the present embodiment, the socket 323 is formed near a lower end of the insert 320.

The U-shaped positioning member 330 has an indentation 331 by which the U-shaped positioning member 330 is engaged with the socket 323 of the insert 320. Referring to FIG. 3, the U-shaped positioning member 330 may have its periphery entirely or partially formed with saw-teeth. Since this part is similar to its counterpart in the vehicle lamp adjustment assembly 100 as described above, the detailed description is omitted herein.

The bolt 340 is to be screwed into the through hole 321 of the insert 320. Since the bolt 340 has its diameter slightly larger than the width of the indentation 331 of the U-shaped positioning member 330, when screwed downward into the insert 320, the bolt 340 pushes the insert 320 outward, in turn making the first saw-toothed segment 322a and the second saw-toothed segment 322b of the insert 320 expand outward.

When the insert 320 is placed into the accommodating space 311 of the fixed base 310, an inner wall of the fixed base 310 defining the accommodating space 311 has a first interference with the saw-toothed segment 322 of the insert 320. In the present embodiment, the accommodating space 311 and the saw-toothed segment 322 of the vehicle lamp adjustment assembly 300 are both of a two-stage structure, which enhances the extent of interference between the insert 320 and the fixed base 310. After the first interference, the inner wall of the fixed base 310 defining the accommodating space 311 has a second interference with the U-shaped positioning member 330 mounted around the insert 320. At last, when the bolt 340 is screwed into the through hole 321, since the bolt 340 has its diameter slightly greater than the width of the indentation 331 of the U-shaped positioning member 330, the insert 320 and the U-shaped positioning member 330 both expand outward, so as to increase friction between the insert 320 and the inner wall of the fixed base 310 defining the accommodating space 311, and meantime edges of the U-shaped positioning member 330 cut into the inner wall of the fixed base 310 defining the accommodating space 311, so the insert 320 in positioned in the fixed base 310.

Moreover, the vehicle lamp adjustment assembly 300 further comprises a pair of vertical tabs 332, positioning stairs 350, positioning recesses 351, a scoop 324 and a fixing portion 360. Since these components are similar to their counterparts of the vehicle lamp adjustment assembly 200 as described in the previous embodiment, the detailed description is omitted herein. What makes the vehicle lamp adjustment assembly 300 different from the above-described vehicle lamp adjustment assembly 200 is that the vehicle lamp adjustment assembly 300 has two positioning stairs 350 and two positioning recesses 351.

The positioning stairs 350 are located in the accommodating space 311 of the fixed base 310 and formed integratedly on the inner wall of the fixed base 310, for preliminarily positioning the insert 320 within the accommodating space 311 of the fixed base 310. In the present embodiment, the positioning stairs 350 are symmetrically formed on the inner wall of the fixed base 310. In other words, the vehicle lamp adjustment assembly 300 has two positioning stairs 350.

The positioning recesses 351 are symmetrically formed on saw-toothed segment 322 of the insert 320. Thus, the vehicle lamp adjustment assembly 300 has two positioning recesses 351 for engaging with the positioning stairs 350, respectively, so as to preliminarily position the insert 320 in the accommodating space 311 of the fixed base 310. The two positioning stairs 350 and the two positioning recesses 351 of the vehicle lamp adjustment assembly 300 help to improve the positioning effect.

It is to be noted that, for working with the two positioning stairs 350 and the two positioning recesses 351 of the vehicle lamp adjustment assembly 300, the U-shaped positioning member 330 further has a notch 333 corresponding to the two positioning stairs 350 and two positioning recesses 351.

From the above embodiments, it is learned that in virtue of the friction between the inner wall of the fixed base defining the accommodating space and the saw-toothed segment of the insert as well as the U-shaped positioning member, plus the design that the bolt is greater than the through hole in diameter, in the disclosed vehicle lamp adjustment assembly, when the bolt is screwed into the through hole, the saw-toothed segment of the insert and the U-shaped positioning member expand outward, thereby firmly positioning the insert in the accommodating space of the fixed base. Additionally, in some embodiments of the present invention, the two-stage structure of the accommodating space and the saw-toothed segment of the vehicle lamp adjustment assembly are helpful to enhance the interference between the insert and the fixed base, so as to prevent the installed insert from disengagement.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A vehicle lamp adjustment assembly, comprising:
a fixed base defining therein an accommodating space;
an insert being installed in the accommodating space of the fixed base and comprising a through hole that passes through the insert axially, a saw-toothed segment having ctenoid structure raised from the insert, and a socket being formed at an outer periphery of the insert;
a U-shaped positioning member having an indentation by which the U-shaped positioning member engages with the socket of the insert; and
a bolt being screwed into the through hole of the insert and having a diameter slightly greater than a width of the indentation of the U-shaped positioning member.

2. The vehicle lamp adjustment assembly of claim 1, further comprising: a pair of vertical tabs formed along inner edges of the indentation of the U-shaped positioning member.

3. The vehicle lamp adjustment assembly of claim 1, further comprising:
a positioning stair located in the accommodating space of the fixed base and integratedly formed on an inner wall of fixed base defining the accommodating space; and
a positioning recess formed on the saw-toothed segment of the insert for engaging with the positioning stair thereby positioning the insert within the accommodating space of the fixed base.

4. The vehicle lamp adjustment assembly of claim 3, wherein each of the positioning stair and the positioning recess comes in a number of two while the U-shaped positioning member additionally has a notch positionally corresponding to the pair of positioning stairs and the pair of positioning recesses.

5. The vehicle lamp adjustment assembly of claim 1, wherein the saw-toothed segment further comprises:
a first saw-toothed segment; and
a second saw-toothed segment bordering on the first saw-toothed segment,
wherein a distance between a periphery of the second saw-toothed segment and a suppositional axis of the through hole is slightly smaller than a distance between a periphery of the first saw-toothed segment and the suppositional axis of the through hole.

6. The vehicle lamp adjustment assembly of claim 5, wherein the accommodating space further comprises:
a first accommodating space configured to match the distance between the periphery of the first saw-toothed segment and the suppositional axis of the through hole; and
a second accommodating space configured to match the distance between the periphery of the second saw-toothed segment and the suppositional axis of the through hole,
wherein the second accommodating space has an inner diameter slightly smaller than an inner diameter of the first accommodating space.

7. The vehicle lamp adjustment assembly of claim 1, wherein the insert includes a crisscross sectional shape and the saw-toothed segment has saw-teeth raised from outer edges of the crisscross sectional shape.

8. The vehicle lamp adjustment assembly of claim 7, further comprising: a scoop formed in the saw-toothed segment and communicates to the through hole of the insert.

9. The vehicle lamp adjustment assembly of claim 1, wherein the U-shaped positioning member has a periphery formed with saw-teeth.

10. The vehicle lamp adjustment assembly of claim 1, further comprising: a fixing portion such integratedly formed on the insert that the fixing portion is located on one end of the insert opposite to the saw-toothed segment.
